(19) United States
(12) Patent Application Publication
(10) Pub. No.: US 2026/0353210 A1
(43) Pub. Date: Nov. 5, 2026

(54) METHODS, ARCHITECTURES, APPARATUSES AND SYSTEMS FOR SENSING MEASUREMENT CONTINUITY WITH WIRELESS TRANSMIT/RECEIVE UNIT MOBILITY

(71) Applicant: InterDigital Patent Holdings, Inc., Wilmington, DE (US)

(72) Inventors: Jongwoo Hong, New York, NY (US); Fumihiro Hasegawa, Westmount (CA); Paul Marinier, Brossard (CA); Ghyslain Pelletier, Montreal (CA); Benoit Pelletier, Roxboro (CA); Kevin Wanuga, Souderton, PA (US)

(21) Appl. No.: 19/199,246

(22) Filed: May 5, 2025

(51) Int. Cl. H04W 36/00; H04W 24/08

(52) U.S. Cl. CPC H04W 36/0085; H04W 24/08

(57) ABSTRACT

Methods and apparatuses are provided for sensing measurement continuity with wireless transmit/receive unit (WTRU) mobility. The WTRU receives, from a wireless network, configuration information indicating a set of downlink signals for a sensing task associated with a plurality of cells, a trigger condition, and a selection criterion. The WTRU performs sensing measurements based on at least one of the set of downlink signals. In response to determining that the trigger condition is met, the WTRU performs signal measurements on each of the set of downlink signals. The WTRU identifies a subset of the set of downlink signals based on the selection criterion. The WTRU performs sensing measurements based on at least one of the subset of downlink signals and reports, to the wireless network, sensing measurement results based on at least one reporting condition.

### TECHNICAL FIELD

The present disclosure is generally directed to the fields of communications, software and encoding/decoding, including, for example, to methods, architectures, apparatuses, systems related to sensing measurement continuity with wireless transmit/receive unit mobility.

### BACKGROUND

Devices (e.g., wireless transmit/receive units) perform sensing, which relies on consistent downlink resources. However, downlink resources may deteriorate for various reasons, for example, device mobility, which can negatively affect the sensing and cause interruption in the sensing.

### SUMMARY

This disclosure describes a wireless transmit/receive unit (WTRU) configured for continuous sensing when a deterioration in downlink resources has occurred. The WTRU receives a sensing configuration with downlink reference signals (DL-RSs) and certain thresholds. The WTRU identifies downlink resources based on signal quality and the thresholds. Upon detection of poor signal quality for sensing, the WTRU transitions to downlink reference signals with better signal quality.

In certain representative embodiments, methods and systems are provided for sensing measurement continuity with wireless transmit/receive unit (WTRU) mobility. The methods and systems may include a WTRU receiving, from a wireless network, configuration information indicating a set of downlink signals for a sensing task associated with a plurality of cells, a trigger condition, and a selection criterion. The methods and systems may further include performing sensing measurements based on at least one of the set of downlink signals. The methods and systems may further include in response to determining that the trigger condition is met, performing signal measurements on each of the set of downlink signals. The methods and systems may further include identifying a subset of the set of downlink signals based on the selection criterion. The methods and systems may further include performing sensing measurements based on at least one of the subset of downlink signals and reporting, to the wireless network, sensing measurement results based on at least one reporting condition.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example of a sensing operation of a WTRU according to one or more embodiments;

FIG. 3 illustrates an example of a 5G System Assisted Automotive maneuvering and navigation according to one or more embodiments;

FIG. 4 illustrates an example of sensing DL-RSs from multiple cells according to one or more embodiments;

FIG. 5 illustrates an example of sensing measurement with WTRU mobility according to one or more embodiments;

FIG. 6 illustrates a process for determination of a sensing DL-RS for sensing measurement based on prioritization according to one or more embodiments;

FIG. 7 illustrates a signaling process for sensing measurements continuity based on priority according to one or more embodiments;

FIG. 8 illustrates a signaling process for network controlled sensing measurements continuity according to one or more embodiments;

FIG. 9 illustrates a signaling process for sensing measurement continuity during a handover procedure according to one or more embodiments;

FIG. 10 illustrates a signaling process for network controlled sensing measurements continuity during a handover procedure according to one or more embodiments; and

FIG. 11 illustrates a method for sensing measurement continuity according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

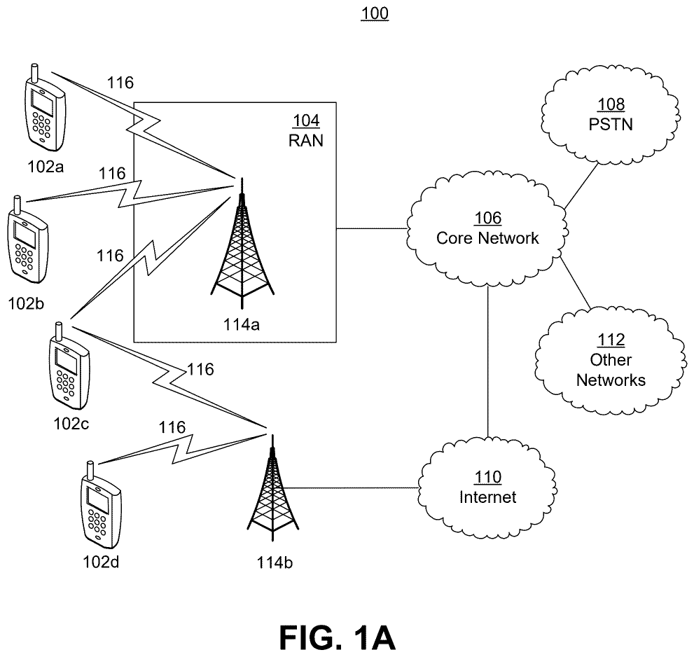

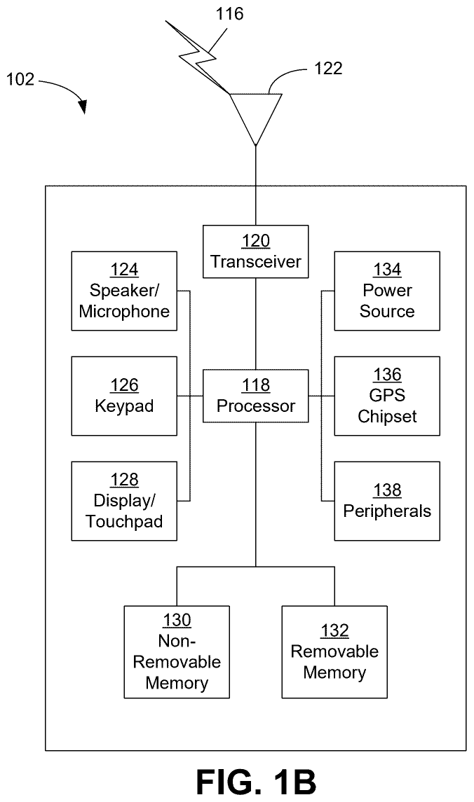

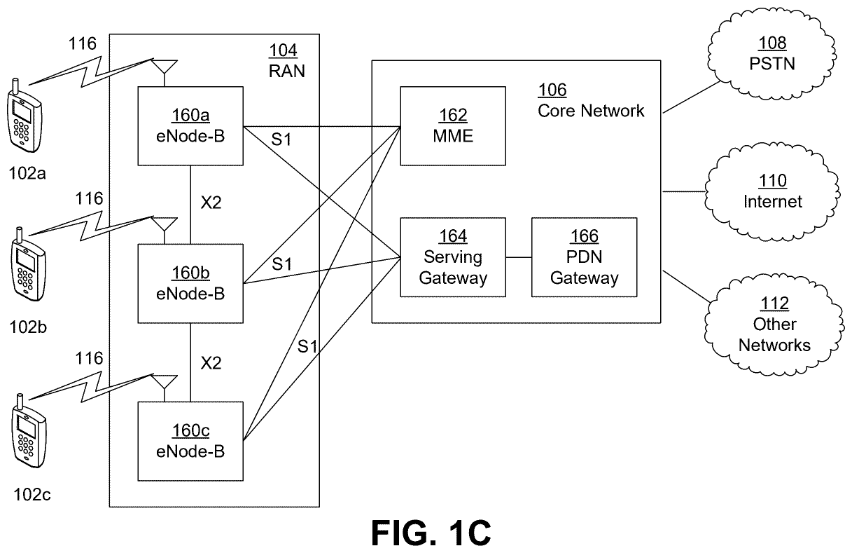

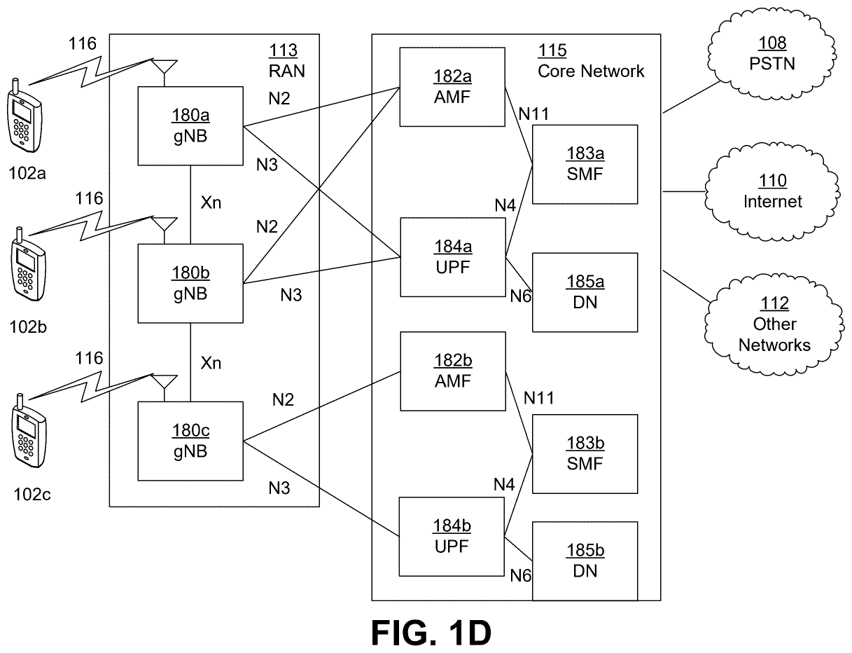

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, wireless sensing (e.g., 5G/6G wireless sensing) may be utilized as a technology enabler to acquire information about characteristics of the environment and/or objects within the environment, that uses radio waves to determine the distance (range), angle, or instantaneous linear velocity of objects, etc. The wireless sensing service may rely on analyzing the transmissions, reflections, and scattering of wireless sensing signals.

In certain representative embodiments, integrated sensing and communication technology for enabling new services and use cases for various industries are provided. Wireless sensing service, as part of a cellular network may provide new possibilities for enhanced usage of the telecommunication infrastructure in areas of object detection and tracking, environment monitoring and human motion monitoring. This may provide input to various verticals-unmanned aerial vehicles (UAVs), smart home, Vehicle-to-Everything (V2X), or factories.

In certain representative embodiments, the use cases may cover a wide range of applications, including: object and intruder detection for smart home, on a highway, for railways, for factory, for predefined secure areas around critical infrastructure; collision avoidance and trajectory tracking of UAVs, vehicles, Automated Guided Vehicles (AGVs); automotive maneuvering and navigation; public safety search and rescue; rainfall monitoring and flooding; health and sports monitoring.

In certain representative embodiments, use cases may include wireless sensing and some of the use cases may include non-3rd Generation Partnership Project (3GPP) type sensors (e.g. Radar, camera). Wireless sensing service may bring challenges related to confidentiality and privacy. There may be a need to protect the sensing data from unauthorized access, interception and eavesdropping, but also to make sure there is compliance with regulation and user awareness. Based on the use cases, system support (e.g., 5G/6G system support) of different use cases and service requirements for Integrated Sensing and Communication are provided.

In certain representative embodiments, sensing in smart homes is provided. Sensing in a smart home may be an example of a typical scenario of indoor/local-area sensing. Considering people spend most of their lifetime indoors, improving the user experience for an indoor scenario is important. Various WTRUs, e.g. a wearable device, a sensor, a smart phone and/or a customer premise equipment (CPE), may be deployed at home. In order to enjoy more comfortable and convenient indoor life, the various devices may be connected via wireless signals to build a smart home platform.

In certain representative embodiments, in addition to communication purposes, wireless signals may also be used for sensing, e.g., monitoring the home environment continuously.

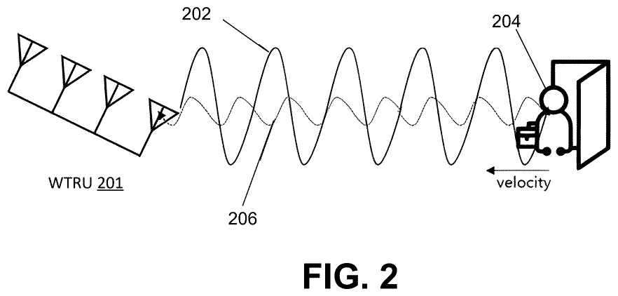

In certain representative embodiments, intruder detection in a smart home scenario is provided. FIG. 2 illustrates an example of a sensing operation of a WTRU 201 according to one or more embodiments. For intruder detection due to the activities of indoor object or human, the signal (e.g., a 3GPP signal) measured by a WTRU or network may be influenced. By analysing and collecting the sensing information such as Doppler frequency shift, amplitude change and phase change, the behaviour of indoor object or human may be detected as shown in FIG. 2. The WTRU 201 may transmit a sensing signal 202 which is reflected by a new reflector 204 (i.e., a moving person with a velocity). A reflected signal 206 may vary in at least one of frequency, phase, amplitude, or time of flight (ToF) from the sensing signal 202.

In certain representative embodiments, to support smart transportation and autonomous driving, more vehicle and devices may be equipped with sensing technologies. In some embodiments, cameras, Radar, and Lidar systems may be the most used sensors by the automotive industry to maintain the perception for autonomous vehicles at various levels of autonomy. Accurate sensing results may be crucial to enable the safe and reliable control of the vehicles.

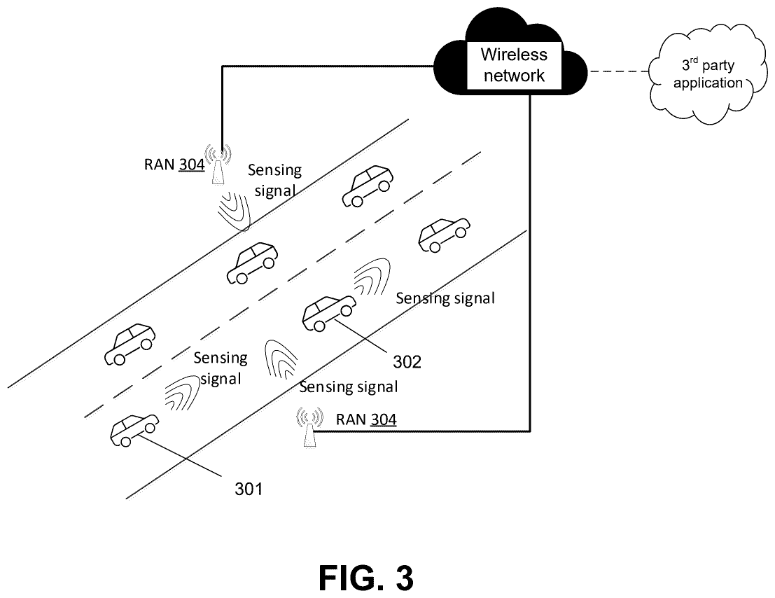

In certain representative embodiments, due to the mounting position of the sensors (e.g., 3GPP based sensors) information collected from a single vehicle's sensors may not be sufficient or accurate enough to satisfy the advanced automotive use cases, e.g., autonomous driving, coordinated maneuver, etc. FIG. 3 illustrates an example of a network (i.e., 5G) system assisted automotive maneuvering and navigation according to one or more embodiments. The system may coordinate sensing to get sensing data from various sources and generate sensing results which may be consumed at the vehicle and used for the vehicular control and driver assistance, e.g., feed into the Automated Driving System (ADS) in the car. The network sensing data (i.e., 3GPP network sensing) collected by the WTRU may be sent alongside relevant sensing information to other sensing entities (including other vehicles, roadside units, and network) for further processing (if required) before sharing with a third-party application as shown in FIG. 3.

The network facilitated NR based sensing described above may significantly improve the sensing reliability and quality, enabling new and advanced automotive use cases.

In certain representative embodiments, a first vehicle 301 and a second vehicle 302 may be equipped with wireless-based (i.e., 3GPP-based) sensing technology. Non-wireless (i.e., non-3GPP) sensors such as radar, camera and lidar sensors may also be available in the vehicles. Additionally, the vehicles 301 and 302 may be capable of wireless (i.e., 5G) communications, including direct communication with other vehicles, communication with 5G system via RAN entities 304.

In certain representative embodiments, a wireless (i.e., 5G) system assisted coordination of sensing service may comprise one or more of the following steps:

Step 1 (Network provides configurations and policies): When a first vehicle 301 registers for 3GPP sensing service, the network 304 may provide policies and configurations to enable WTRUs take appropriate actions during sensing e.g., obtaining 3GPP sensing data from other WTRUs/RAN entities. In some embodiments, the policies provided by network may provide guidance for the discovery WTRUs/RAN entities with appropriate radio (i.e., New Radio Reference Frequency NR RF) sensing capabilities, when to trigger requests, when to stop sending requests, messaging formats, the communication configurations (such as which 5G communication mode to use and under which conditions), the sensing configurations (such as which role i.e. transmitter/receiver, to use by a particular node for a particular sensing task, etc. These polices and configurations may be updated frequently by the network based on e.g., network conditions, mobility pattern, etc.

Step 2 (The first vehicle 301 may determine its sensors are blocked): the first vehicle's sensor(s) may be blocked by a second vehicle 302, and may not adequately detect its surroundings (e.g., detect if there is another vehicle in front). This may result in the vehicle miscalculating the needed distance to stop before a traffic light. In other cases, the second vehicle 302 may also reduce the valid sensing region and result in misdetection of incoming vehicles size or shape, especially near intersections. The sensing results may not fully satisfy the autonomous driving needs and requirement.

Step 3 (the first vehicle 301 may recognize need for sensing inputs): Due to unsatisfactory autonomous driving needs and requirements, the WTRU in the first vehicle 301 may be notified that its sensors are blocked and needed wireless (i.e., 5G) system assistance for coordination of the sensing service.

Step 4 (the first vehicle 301 may discover the second vehicle 302): With the policies and configurations provided by the wireless system, the first vehicle 301 may search for neighbouring WTRUs/RAN entities or ask the network to provide recommendations for WTRUs/RAN entities (e.g., considering the current network conditions in the target sensing area) and their wireless (i.e., 3GPP NR RF) sensing capabilities (e.g., if WTRU/RAN entity may support sensing service). This information may be used to discover other vehicles and RAN entities with wireless (i.e., 3GPP NR RF) sensors that can support sensing in the area. In this embodiment, the first vehicle 301 discovered the second vehicle 302 which may be useful in providing sensing inputs.

Step 5 (the first vehicle 301 may connect to the second vehicle 302): the first vehicle 301 may then establish wireless (5G) communication connection with the second vehicle 302 and/or RAN entities. The most suitable 5G communication mode (e.g., broadcast, unicast, etc.) may be determined by the first vehicle 301 based on wireless (i.e., 5G) system configuration and policies.

Step 6 (the first vehicle 301 may request sensing info from the second vehicle 302). The request may indicate the information needed to perform sensing, e.g., the additional region to be covered, additional sensing target, synchronization info, etc.

Step 7 (the second vehicle 302 may send sensing results/wireless (i.e., 3GPP) sensing data to the first vehicle 301) Based on the information provided by the first vehicle; the second vehicle 302 may send the first vehicle 301 wireless (i.e., 3GPP) sensing data identifying objects in its surroundings. It is important to note that when wireless sensing data is shared between the second vehicle 302 and the first vehicle 301, it is expected to be performed in compliance with operator policy on the use of the operator resources (e.g., licensed/unlicensed spectrum).

Step 8a (the first vehicle 301 may process 3GPP sensing data locally) Based on the fact that the first vehicle 301 has non-3GPP sensors (e.g., camera, Lidar), the first vehicle 301 may combine the 3GPP sensing data from the second vehicle 302 with other sensors.

Step 8b (The 5G System expose sensing results to third-party application) Additionally or alternatively the first vehicle 301 may share sensing results and non-3GPP sensing data from the camera and Lidar within the wireless (i.e., 5G) system and then it is exposed by the 5G System to a third-party application server for combination by the third-party. It is important to note that contextual information is information forwarded alongside the sensing results which provide context to the conditions under which the sensing results were derived. This contextual information can be used in scenarios where the sensing result is to be combined with data from other sources. It should also be noted that in case contextual information is required, this information may be shared with the appropriate consent, permissions and subject to operator policy.

In certain representative embodiments, a Downlink-Reference Signal (DL-RS) configuration may contain at least one of the following parameters: number of symbols, transmission power, number of DL-RS resources included in DL-RS resource set, muting pattern for DL-RS (for example, the muting pattern may be expressed via a bitmap), periodicity, type of DL-RS (e.g., periodic, semi-persistent, or aperiodic), slot offset for periodic transmission for DL-RS, vertical shift of DL-RS pattern in the frequency domain, time gap during repetition, repetition factor, RE (resource element) offset, comb pattern, comb size, spatial relation (e.g., with respect to other DL-RSs or Uplink Reference Signal (UL RS) such as Sounding Reference Signal (SRS) for positioning purpose), Quasi co-location (QCL) information (e.g., QCL target, QCL source) for DL-RS, number of Transmission/Reception Points (TRPs), Absolute Radio-Frequency Channel Number (ARFCN), subcarrier spacing, expected Reference Signal time difference (RSTD), uncertainty in expected RSTD, start Physical Resource Block (PRB), bandwidth, Bandwidth Part (BWP) ID, number of frequency layers, start/end time for DL-RS transmission, on/off indicator for DL-RS, TRP ID, DL-RS ID, cell ID, global cell ID, or applicable time window. The WTRU may apply a DL-RS configuration under a condition that the current time is within the applicable time window. “ID” may be used interchangeably with “index”. Examples of DL-RS may be Channel State Information-Reference Signal (CSI-RS), Phase Tracking-Reference Signal (PTRS), Positioning Reference Signal (PRS), Tracking Reference Signal (TRS), and Synchronization Signal Block (SSB).

In certain representative embodiments, a sensing configuration may consist of one or more DL-RS configurations. A sensing configuration may consist of measurement or reporting related configurations (e.g., periodicity of measurement or reporting, measurement or reporting trigger conditions, content of the measurement). A sensing configuration may consist of a combination of RS configurations, measurement and/or reporting configurations.

In certain representative embodiments, a handover procedure with sensing measurements is provided.

In certain representative embodiments, a method and apparatus for reporting sensing status for sensing measurement continuity is provided.

In certain representative embodiments, a WTRU may receive a sensing configuration with sets of sensing DL-RSs and one or more thresholds.

In certain representative embodiments, a WTRU may determine a set of candidate cells based on a measured Reference Signal Received Power (RSRP) of Synchronization Signal Block (SSB) of cells.

In certain representative embodiments, a WTRU may select and measure sensing DL-RSs with priority based on measurement with a set of candidate cells.

In certain representative embodiments, upon receiving a handover command, a WTRU may report sensing status to a source cell or target cell.

In certain representative embodiments, a WTRU may report sensing measurement results if a condition for sensing reporting is satisfied.

In certain representative embodiments, upon receiving a handover command, a WTRU may report sensing measurement results.

In certain representative embodiments, in a handover (HO) scenario, a WTRU (e.g., connected) may be scheduled DL resource for DL data communication during the HO procedure (e.g., between cells and core network).

In certain representative embodiments, in sensing measurement, gNB (or sensing server) may configure sensing configuration with at least one DL signals for obstacle detection from one or more TRP(s) of the cell(s). For sensing measurements for obstacle detections, a WTRU may select one or more set(s) of DL sensing resources (e.g., RBs, BWP, hopping patterns).

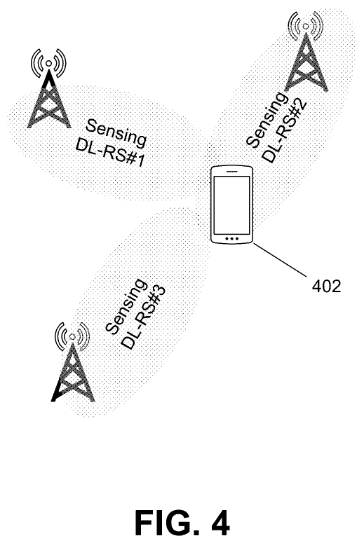

FIG. 4 illustrates an example of sensing DL-RSs from multiple cells according to one or more embodiments. A WTRU 402 may determine a set of DL sensing resources associated among the multiple cell(s). When the WTRU 402 has mobility, the measured value of DL resource may change according to the WTRU 402 mobility. Hence the WTRU 402 may have to determine the set of DL resource considering the WTRU 402 mobility.

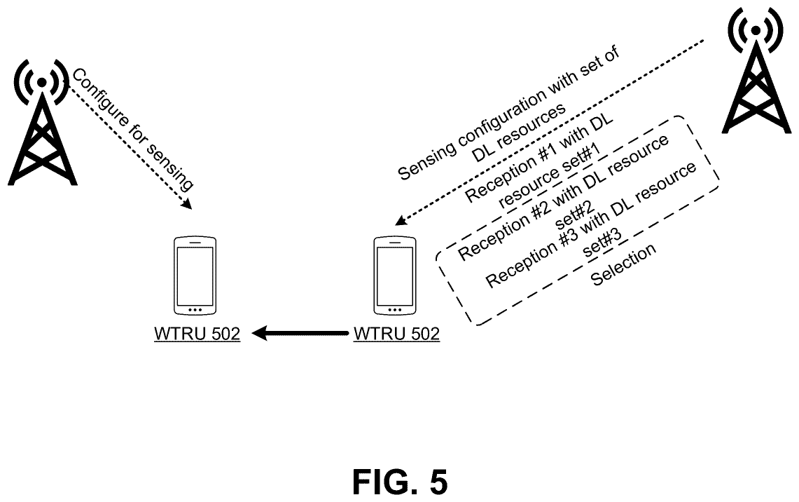

In some embodiments, for an obstacle detection, the WTRU may select one or more set(s) of DL resources dynamically within the configuration based on certain conditions (e.g., DL-RSRP, QoS requirement). FIG. 5 illustrates an example of sensing measurement with WTRU mobility according to one or more embodiments. In certain representative embodiments, the WTRU 502 may receive an activation of sensing measurement with set(s) of DL resources and related sensing configuration from network.

In certain representative embodiments, if HO is triggered due to WTRU mobility, the network (e.g., new target cell) may not have any information on which sets of DL resources are selected with conditions for sensing measurement in the previous cell (e.g., source cell). When the network sends handover command, the target cell may have no information regarding the selected DL resource with sensing measurement from the source cell. In some embodiments, the network may not know whether the current sensing measurement configured by the source cell is terminated or not. In some embodiments, if sensing measurement is not terminated, the network may determine to perform sensing measurement via source cell or target cell to support sensing measurement continuity of sensing measurement.

In certain representative embodiments, support for sensing measurement continuity when a connected WTRU has mobility (e.g., handover procedure) is provided.

In certain representative embodiments, a WTRU may be configured with sensing configurations that span over more than one cell. The DL-RSs for sensing purpose may be associated with SSBs associated with cells. The WTRU may determine which cells'DL-RSs to utilize for measurements based on the configuration and priority.

In certain representative embodiments, a WTRU may receive configurations from a network. The configuration may contain more than one cell. Each of the cells may be associated with at least one SSB. One of the SSBs may be configured with sensing-SSB (S-SSB) and associated with more than one sensing DL-RSs. One or more RSRP thresholds with SSBs and/or S-SSBs may be provided with the configuration.

In certain representative embodiments, if measured RSRP of SSB from the serving cell is less than a configured threshold, a WTRU may perform measurements on SSBs for neighboring cells.

In certain representative embodiments, if RSRP of SSBs associated cell is above a configured threshold, a WTRU may determine candidate cells.

In certain representative embodiments, a WTRU may perform measurements on the candidate sensing DL-RSs associated with the candidate cells: a WTRU may determine priority of measurement on candidate sensing DL-RSs based on the RSRP of S-SSBs (e.g., from the highest) among the candidate cells.

In certain representative embodiments, a WTRU may report measurement results of neighboring cells and receives the target cell information via RRC message.

In certain representative embodiments, a WTRU may report the sensing measurements to the target cell if at least one of conditions is satisfied. In some embodiments, the conditions may be at least one of a sensing measurement contains/detected multipath, a Change in the sensing measurement may be above the configured threshold, sensing measurement associated with sensing configuration is activated.

In certain representative embodiments, a WTRU may select and measure sensing DL-RSs of cells with priority during handover procedure. The WTRU may keep performing the sensing measurement with high RSRP cell and reporting the sensing measurement with certain conditions.

In this disclosure, the term network may be used interchangeably with AMF, Location Management Function (LMF), LMF-like, gNB, eNB or NG-RAN or core network or sensing server.

In this disclosure, the term sensing server may be used interchangeably with AMF, sensing-LMF, LMF-like, or core network.

An LMF is a non-limiting example of a node or entity (e.g., network node or entity) that may be used for or to support positioning or sensing. Any other node or entity may be substituted for LMF (or like-LMF) and still be consistent with this disclosure.

In this disclosure, the term WTRU may be used interchangeably with sensing WTRU, activated sensing WTRU or a WTRU with sensing measurement and reporting capabilities.

In this disclosure, the term “SSB”, “DL-RS” may be used interchangeably to the “sensing SSB” or “sensing DL-RSs” for the sensing measurement.

In this disclosure, “Network” may correspond to a function, node and/or a protocol that terminates in the radio access e.g., gNB, NG-RAN entity or in the core network e.g., AMF, LMF, data collection function or similar.

In certain representative embodiments, RSTD may be defined by the difference in time of arrival between PRSs transmitted from a reference TRP and target TRP. The WTRU may be configured with the reference TRP index and target TRP index. The WTRU may be configured with the PRS resource indices to make measurements. The WTRU may determine the time of arrival from TRP based on one or more PRS resources associated with the TRP. In some embodiments, the RSTD may be defined as the difference in time of arrival between the reference PRS transmitted from a TRP and the target PRS transmitted from a TRP.

In some embodiments, “WTRU Rx-Tx time difference” may refer to the difference between arrival time of the reference signal transmitted by the TRP and transmission time of the reference signal transmitted from the WTRU. The WTRU Rx-Tx time difference may be associated with PRS resource ID and/or SRSp resource ID.

In some embodiments, the WTRU may obtain CIR (Channel Impulse Response) from the network. The network may indicate DL-RS configuration(s) such as DL-RS resource IDs associated with the CIR. In some embodiments, the CIR may be associated with DL-RS resource ID. In this case, the WTRU may determine that the CIR is derived based on the measurements made on the DL-RS resource associated with the ID. Alternatively, the WTRU may determine that the channel along the direction of transmission of the DL-RS or reception of the DL-RS corresponds to the CIR.

In some embodiments, the CIR may be associated with a TRP ID. In this case, the WTRU may determine that the CIR represents the channel between the associated TRP and WTRU. In some embodiments, the CIR may be associated with more than one TRPs where the network may include TRP indices associated with the CIR.

In some embodiments, the CIR may be associated with a cell. In this case, the WTRU may receive cell ID or index associated with the CIR from the network.

In some embodiments, CIR may be associated with more than one TRPs or DL-RS resource IDs. In this case, the WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

In some embodiments, more than one CIRs may be associated with one parameter from DL-RS configurations (e.g., TRP ID, DL-RS resource ID, frequency layer ID). In some embodiments, the WTRU may receive information related to 2 CIRs associated with a TRP from the network. Alternatively, the WTRU may report information related to more than one CIRs associated with DL-RS configuration (e.g., TRP ID, DL-RS resource ID) based on the measurements to the network. There may be more than one CIRs associated with DL-RS configuration since the WTRU or network may observe different channel characteristics based on AoA of DL RS or UL RS, for example.

Channel impulse response may be represented by channel delay profile such as DP (delay profile) or PDP (power delay profile). A power delay profile may be defined as a set of delays and power profiles, such as [τ₀, τ₁, . . . , τ_{N-1}] and [p₀, p₁, . . . , p_{N-0}] , where pₖ may corresponds to relative power at the k^{th} path compared to the first path. A delay profile may be defined as a set of delays [τ₀, τ₁, . . . , τ_{N-1}], with respect to a reference timing (e.g., first path, indicated reference timing), which may indicate a path delay for each path. Each path may have a path power above p_{threshold}. The WTRU may receive p_{threshold} from the network to derive delay profile from power delay profile.

In some embodiments, the channel impulse response the WTRU reports to the network may be defined by configured number of samples (e.g., N) where the WTRU is configured with granularity of samples (e.g., X seconds apart). The WTRU may report samples whose RSRP is over the configured threshold or M highest RSRP among the samples. The WTRU may indicate locations or sample index of samples where the WTRU measures M highest RSRP samples. The first sample may be defined as the earliest arriving path, e.g., first path. The WTRU may report timing, phase and/or power information per sample.

In some embodiments, the WTRU may receive an indication from the network on how to generate CIR, PDP or DP based on timing, phase and/or power measurements. In some embodiments, the WTRU may send a request to the network to receive an indication on which methodologies to use to generate CIR, PDP or DP based on the measurements the WTRU made. In some embodiments, the WTRU may receive a message from the network (e.g., via LPP, RRC, MAC-CE, DCI) indicating the DL-RS resource indices and associated measurement type(s) (e.g., RSTD, AOA) to use to generate CIR, PDP or DP. In some embodiments, the WTRU may receive an indication from the network indicating to generate CIR, PDP or DP.

In some embodiments, the WTRU may receive a threshold (e.g., power threshold) from the network and timing range (e.g., 0 μs to 1 μs), timing granularity (e.g., every 0.1 μs in the indicated timing range, 100 sample points in the indicated timing range) of CIR, PDP and/or DP. In this case, the WTRU may determine to report power and timing (e.g., relative timing compared to a reference timing, absolute timing) any samples whose received power is over the threshold.

The WTRU may send measurements in a report to the network (e.g., LMF, gNB) via a semi-static (e.g., LPP, RRC) or dynamic message (e.g., UCI, UL MAC-CE).

In some embodiments herein, DL-RS (e.g., CSI-RS, DM-RS, TRS) and SSB may be used interchangeably.

In some embodiments herein, measurements and/or reporting of measurements may refer to actual measurements and/or other, possibly associated, quantities. Such quantities may include post-processed measurements and/or a determined characterization thereof (e.g., timing, signal processing window, number of samples or the likes).

In some embodiments, RSCP (RS Carrier Phase) may be defined as the carrier phase measurement on the PRS and RSCPD (RSCP Difference) may be defined as difference in carrier phase measurements between two PRS resources.

In some embodiments, RSRP per path may be defined as the RSRP per path if the WTRU observers a multipath channel in the measurement. The WTRU may determine RSRP for a DL RS resource. RSRP or RSRPP may be reported using units dBm or relative power difference compared to a reference, e.g., RSRP of the first path, in dB.

In some embodiments, the WTRU may obtain CIR (Channel Impulse Response) from the network. The network may indicate DL-RS configuration(s) such as DL-RS resource IDs associated with the CIR. In some embodiments, the CIR may be associated with DL-RS resource ID. In this case, the WTRU may determine that the CIR is derived based on the measurements made on the DL-RS resource associated with the ID. Alternatively, the WTRU may determine that the channel along the direction of transmission of the DL-RS or reception of the DL-RS corresponds to the CIR.

In some embodiments, the CIR may be associated with a TRP ID. In this case, the WTRU may determine that the CIR represents the channel between the associated TRP and WTRU. In some embodiments, the CIR may be associated with more than one TRPs where the network may include TRP indices associated with the CIR.

In some embodiments, the CIR may be associated with a cell. In this case, the WTRU may receive cell ID or index associated with the CIR from the network.

In some embodiments, CIR may be associated with more than one TRPs or DL-RS resource IDs. In this case, the WTRU may determine that the channel between the TRPs and the WTRU corresponds to the CIR. Alternatively, the WTRU may determine that the channel along the transmission directions of DL-RSs associated with IDs or reception directions of the DL-RS correspond to the CIR.

In some embodiments, more than one CIRs may be associated with one parameter from DL-RS configurations (e.g., TRP ID, DL-RS resource ID, frequency layer ID). In some embodiments, the WTRU may receive information related to 2 CIRs associated with a TRP from the network. Alternatively, the WTRU may report information related to more than one CIRs associated with DL-RS configuration (e.g., TRP ID, DL-RS resource ID) based on the measurements to the network. There may be more than one CIRs associated with DL-RS configuration since the WTRU or network may observe different channel characteristics based on AoA of DL RS or UL RS, for example.

Channel impulse response may be represented by DP (delay profile) or PDP (power delay profile). A power delay profile may be defined as a set of delays and power profiles, such as [τ₀, τ₁, . . . , τ_{N-1}] and [p₀, p₁, . . . , p_{N-0}] , where pₖ may corresponds to relative power at the k^{th} path compared to the first path. A delay profile may be defined as a set of delays [τ₀, τ₁, . . . , τ_{N-1}], with respect to a reference timing (e.g., first path, indicated reference timing), which may indicate a path delay for each path. Each path may have a path power above p_{threshold}. The WTRU may receive p_{threshold} from the network to derive delay profile from power delay profile.

In some embodiments, the channel impulse response the WTRU reports to the network may be defined by configured number of samples (e.g., N) where the WTRU is configured with granularity of samples (e.g., X seconds apart). The WTRU may report samples whose RSRP is over the configured threshold or M highest RSRP among the samples. The WTRU may indicate locations or sample index of samples where the WTRU measures M highest RSRP samples. The first sample may be defined as the earliest arriving path, e.g., first path. The WTRU may report timing, phase and/or power information per sample.

In some embodiments, the WTRU may receive an indication from the network on how to generate CIR, PDP or DP based on timing, phase and/or power measurements. In one example, the WTRU may send a request to the network to receive an indication on which methodologies to use to generate CIR, PDP or DP based on the measurements the WTRU made. In some embodiments, the WTRU may receive a message from the network (e.g., via LPP, RRC, MAC-CE, DCI) indicating the DL-RS resource indices and associated measurement type(s) (e.g., RSTD, AOA) to use to generate CIR, PDP or DP. In some embodiments, the WTRU may receive an indication from the network indicating to generate CIR, PDP or DP.

In some embodiments, the WTRU may receive a threshold (e.g., power threshold) from the network and timing range (e.g., 0 μs to 1 μs), timing granularity (e.g., every 0.1 μs in the indicated timing range, 100 sample points in the indicated timing range) of CIR, PDP and/or DP. In this case, the WTRU may determine to report power and timing (e.g., relative timing compared to a reference timing, absolute timing) any samples whose received power is over the threshold.

The WTRU may send measurements in a report to the network (e.g., LMF, gNB) via a semi-static (e.g., LPP, RRC) or dynamic message (e.g., UCI, UL MAC-CE).

In some embodiments, a WTRU (e.g., sensing WTRU) may receive a configuration including one or more sensing configurations associated TRP(s) and/or cell(s) from base station and/or core network (e.g., a new entity with supporting sensing function, like the LMF. In some embodiments, the sensing configuration of the TRP(s) and/or cell(s) may be configured to one or more WTRUs via NAS layer signaling between WTRU and core network. In some embodiments, the sensing configuration may be configured to one or more WTRUs via AS layer signaling between WTRU and base station. In some embodiments, a base station may transmit a message (e.g., sensing configurations/parameters with including conditions) to the WTRUs via RRC SIB and/or RRC dedicated message. In some embodiments, a base station may activate (e.g., indication) the configured sensing configuration via DCI/MAC CE/RRC.

In some embodiments, a sensing configuration may be configured to one or more WTRUs via NAS signaling between WTRU and core network. In some embodiments, the sensing configuration may be configured to one or more WTRUs via NAS signaling between WTRU and core network. In some embodiments, a core network may transmit a NAS message and enable/activate one or more configured sensing configurations.

In some embodiments, each of the sensing configurations may comprise associated at least one DL/UL signals with one or more threshold(s) and/or UL resource (e.g., reporting of sensing measurement results) and/or associated with a periodicity (e.g., when to report sensing results) and/or triggering reporting conditions. In some embodiments, DL signal(s) is associated with at least frequency/a range of resource block(s)/BWP/SS/PBCH/SSB/SSS/sensing SSB/sensing DL-RSs. In some embodiments, a WTRU may receive a synchronization signal/physical broadcast channel (SS/PBCH) block. The SS/PBCH block (SSB) may include a primary synchronization signal (PSS), secondary synchronization signal (SSS), and physical broadcast channel (PBCH). The WTRU may monitor, receive, or attempt to decode an SSB during performing sensing measurement operation.

In some embodiments, each of the DL signals may be associated with one or more thresholds. In some embodiments, the threshold is associated with one of the measured values e.g., SSB-RSRP and/or SSB-RSRQ and/or SSB-SINR and/or SS-RSRP and/or SS-RSRQ and/or SS-SINR. In some embodiments, each of the threshold of the DL signal is associated with an obstacle detection (dynamic detection) and/or building detection (semi-static detection). In some embodiments, when the measured value is below than a threshold (during a certain duration time), the WTRU may determine an obstacle being detected and trigger to report the sensing measurement results to the network.

In some embodiments, a sensing configuration may comprise sets of DL (sensing) resources/DL-RSs and associated conditions for selecting and/or monitoring. In some embodiments, a condition may indicate to activate and/or select/monitor set(s) of DL sensing resources/DL-RSs among the configured set(s) of DL sensing resources/DL-RSs. In some embodiments, the condition may be associated with DL-RSRP values and/or QoS requirement for sensing measurement and/or a specific location.

In certain representative embodiments, a WTRU may receive a sensing configuration from a network. The configured sensing configuration may include information associated with one or more cells/TRPs and/or sets of DL sensing resources. In some embodiments, the set of DL sensing resources associated at least one DL signals from cell(s)/TRP(s), for example, sensing DL-RSs, sensing SSB, SSB, (a specific range of) Resource Block, BWP, new (sub-)channel with new channel (or DL data shared channel)) and associated triggering sensing measurement conditions. In some embodiments, a WTRU may prioritize/select/activate one or more sets of DL sensing resources, if at least one of: priority on measurement, activation via lower/higher layer signaling, DL measurement value, QoS requirement, or location condition is satisfied.

Priority on measurement: In some embodiments, a WTRU may prioritize sensing measurement based on measured value (e.g., DL-RSRP, DL-RSRQ) DL signal from a cell/TRP. The measure value is associated at least one sets of DL sensing resources and/or DL signals and at least one cell/TRP. In some embodiments, if the measured value of DL signal of the cell is high (or low), then the cell may be considered higher (or lower) priority to measure among the configured/measuring cells.

In some embodiments, a priority condition may comprise one or more thresholds (e.g., DL-RSRP and/or DL-RSRQ). In some embodiments, a WTRU may determine/select to perform sensing measurement one or more sensing DL-RSs associated a cell based on the received thresholds. Upon receiving the thresholds, the WTRU may consider a candidate cells (e.g., a set of candidate cells), if measured value of each of the candidate cells with is above the configured threshold. The WTRU may determine to measure all sensing DL-RSs of the candidate cells if measured value of each of the candidate cell is above the configured threshold.

In some embodiments, a WTRU may receive an indication from network. The indication may indicate to measure one or more high priority cells (e.g., from the highest priority) among the configured cells. In some embodiments, upon receiving the indication, the WTRU may prioritize to measure associated sets of DL sensing resources with the high priority cell.

In some embodiments, a WTRU may determine the number of candidate cells based on WTRU capability of measuring on sets of DL sensing resources or a cells/TRPs. In some embodiments, if WTRU has a limited capability (e.g., the number of cells and/or measure limited resource blocks/DL-RSs), the WTRU may prioritize to measure sensing DL-RSs or cells/TRPs according to the WTRU capability considering the priority levels (from the highest priority level).

In some embodiments, if WTRU has DL data activity (e.g., DL data reception or monitoring other DL-RSs), the WTRU may prioritize to measure sensing DL-RSs or cells/TRPs according to the WTRU capability considering the priority level (from the highest priority level). In some embodiments, if WTRU has DL data activity, the WTRU may deprioritize to measure sensing DL-RSs or cells/TRPs according to the WTRU capability considering the priority level (from the lowest priority level).

Activation via lower/higher layer signaling: In some embodiments, a WTRU may receive one or more sensing configuration from network. The WTRU may be preconfigured with at least one sensing configuration. Each of the sensing configuration may comprise at least one set of DL sensing resource and associated at least one cell/TRP.

In some embodiments, upon receiving an indication of activation (e.g., sensing measurement), a WTRU may activate/override at least the indicated sensing configuration among the configured sensing configurations. In some embodiments, the indication of activation may indicate at least one sensing configuration (e.g., via explicit index/bit/bitmap) via DCI/MAC CE/RRC message (e.g., reconfiguration and/or reconfiguration with sync and/or handover (HO) command)/NAS message (e.g., via L1/L2/L3/upper layer signaling). In some embodiments, the indication of activation may indicate and associated at least one TRP and/or cell and/or associated at least one DL signal (e.g., sensing SSB/sensing DL-RSs).

In some embodiments, a WTRU may activate all/a part of the indicated/activated DL sensing resources associated a cell/TRP. In some embodiments, the WTRU may receive the indication of activation from source cell and/or target while the WTRU has mobility (e.g., lower-layer triggered mobility or handover procedure). In some embodiments, the WTRU may receive the indication of activation via LTM cell switch command MAC CE (e.g., within the MAC CE for LTM or new MAC CE).

In some embodiments, a WTRU may keep performing sensing measurement upon receiving a handover command (e.g., reconfiguration with sync). In some embodiments, the WTRU may keep performing sensing measurement before/after performing RACH procedure to the new/target cell.

DL measurement value: In some embodiments, a condition may indicate a threshold (e.g., absolute/relative) of measured value (e.g., DL-RSRP, DL-RSRQ) with at least one sets of DL sensing resources and/or DL signals (e.g., DL-RSs, S-SSB, SSB, RB). In some embodiments, a WTRU may activate to measure/monitor all DL resource and/or DL-RSs with measured value upon satisfying the condition (e.g., below than the configured threshold). In some embodiments, a WTRU may activate to measure and/or monitor all DL resource and/or DL-RSs with measured value upon satisfying the condition (e.g., above than the configured threshold with changed value).

In some embodiments, a WTRU may measure and/or monitor all the configured DL resource/DL-RSs with measured value with a hopping pattern. In some embodiments, the hopping pattern (e.g., how to switch between DL sensing resources/DL-RSs) can be configured by network or pre-configured.

In some embodiments, a WTRU may measure and/or monitor the sets of DL sensing resources with measured value during at least within time duration/window (e.g., msec/sec/hour) upon satisfying the condition (e.g., below than the configured threshold and/or above than the configured threshold with changed value). The time duration/window may be associated with at least one configured/activated DL sensing resource.

In some embodiments, a WTRU may measure and/monitor all the sets of DL sensing resources with measured value during the time duration/window (e.g., msec/sec/hour) until satisfying the condition (e.g., at least one obstacle is detected and/or at least one multipath is detected).

QoS requirement: In some embodiments, a condition may indicate a QoS requirement with sensing configuration associated sets of DL sensing resources. In some embodiments, a WTRU may be configured/received a QoS requirement when the WTRU received sensing configuration and/or sensing service is triggered by upper layer (e.g., via NAS signaling). Each of the sensing configuration may be associated with at least one QoS requirement and/or QoS value.

In some embodiments, a WTRU may be reconfigured with an updated QoS requirement with sensing configuration and/or be activated with one of the sensing configurations with updated QoS requirement from network via semi persistent or dynamic method. The QoS requirement may be associated with measurement accuracy (e.g., detecting obstacle(s) and/or multipath(s)) and/or a latency (e.g., required time for detecting obstacle) and/or a number of detected obstacles.

The QoS requirement may comprise at least one QoS value (e.g., 1 to N). In some embodiments, when the QoS requirement is high, then the WTRU may need to measure and/or monitor/activate more sets of DL sensing resources (e.g., large range of resource blocks, measuring more DL-RSs) to satisfy the QoS requirement.

In some embodiments, upon satisfying the QoS condition, a WTRU may measure/monitor/activate each of the DL sensing resources/DL-RSs with measured value (e.g., below than the threshold). In some embodiments, the WTRU may configure to measure/monitor (all of/part) of the DL sensing resources/DL-RSs upon satisfying the condition.

In some embodiments, a WTRU may measure/monitor/activate all DL resource/DL-RSs with measured value during at least a time duration/window (e.g., msec/sec) (with a hopping pattern) upon satisfying the condition. The time duration/window may be associated with at least one QoS requirement and/or QoS value.

Location: In some embodiments, a WTRU may receive a sensing configuration associated a specific location. The location may indicate geographical location and/or location zones (e.g., a mapping with a location associated sensing configuration). In some embodiments, a WTRU may be (pre-)configured/received a location associated with selection of sets of DL sensing resources when the WTRU received sensing configuration and/or sensing service is triggered by upper layer.

In some embodiments, a sensing configuration associated location may comprise conditions for configuring/activating a set of DL sensing resources. In some embodiments, a WTRU may select/monitor/active one or more DL sensing resources/DL-RSs dynamically when the WTRU moves the specific location #1 (e.g., upon satisfying the conditions for location #1). In some embodiments, the WTRU moves the different location (e.g., location #2), the WTRU may select/monitor/activate the different one or more DL sensing resources/DL-RSs (associated location #2) dynamically.

In some embodiments, a sensing configuration associated location may comprise a hopping pattern with a set of DL sensing resources. In some embodiments, a WTRU may select/monitor/active one or more a set of DL sensing resources based on the hopping pattern #1, dynamically once the WTRU moves the specific location #1 (e.g., upon satisfying the conditions for location #1). In some embodiments, the WTRU moves the different location (e.g., location #2), the WTRU may select/monitor/activate the different one or more a set of DL sensing resources based on the hopping pattern #2 (associated location #2) dynamically.

In some embodiments, a sensing configuration associated location may comprise at least a cell/TRP information. In some embodiments, the WTRU may select/monitor/active one or more sets of DL sensing resources in the source cell or target cell or another cell (e.g., serving cell or non-serving cell).

In certain representative embodiments, a WTRU may perform sensing measurement based on the received sensing configuration from network. In some embodiments, the sensing configuration may be different from the measurement configuration for DL/UL data communication. According to the WTRU mobility, the WTRU (e.g., RRC connected) may receive handover command message (e.g., reconfiguration message) from a cell (e.g., source cell). For sensing measurement continuity during handover procedure, the WTRU may report measurement results including the source cell and/or target cell and/or neighboring cells for handover determination by network.

In some embodiments, for sensing measurement continuity, a WTRU may report information related sensing measurement results (e.g., sensing status) that the current serving network may enable to support/provide a sensing measurement continuity for performing sensing measurement to the WTRU. In some embodiments, the WTRU may trigger to report the sensing status, e.g., upon receiving a handover command message and/or measured DL-RSRP value (or delta change) via the source cell is below than the configured threshold and/or measured DL-RSRP value via target source cell is above than the configured threshold and/or sensing measurement with the current sensing configuration is terminated and/or an event is triggered (e.g., sensing measurement reporting).

In some embodiments, a WTRU may report the sensing status to the serving network (e.g., target cell or source cell). The sensing status may be associated with the current configured sensing configuration with performing sensing measurement. In some embodiments, a WTRU may report the sensing status via dedicated RACH preamble/UCI/MAC CE/RRC message/NAS message to the network.

In some embodiments, a WTRU may determine to send the sensing measurement report (e.g., power, delay profile, timing or phase measurement made on the received DL signals such as SSB or DL-RS) to the source or target cell based on a condition. In some embodiments, the WTRU may be configured to report sensing measurements to the source cell if the WTRU receives a handover command (e.g., reconfiguration with sync, LTM cell switch command MAC CE) from the network where the handover command may include an indication which cell(s) to report sensing measurements.

In some embodiments, a WTRU may report the sensing status/sensing measurement results with including an indication and/or assistance information. In some embodiments, the sensing status may comprise, e.g., an indication (e.g., 1 bit) and/or assistance information with indication and/or signaling and/or message.

Indication of termination: In some embodiments, a sensing status may include an indication (e.g., 1 bit indication) whether the current sensing measurement is terminated or not. In some embodiments, the indication value “1” may indicate that current sensing measurement is on-going and not terminated. In some embodiments, the indication value “0” may indicate that current sensing measurement is terminated.

In some embodiments, the sensing status may include another indication. In some embodiments, the indication value “1” may indicate that a request to receive another new sensing configuration with a target cell. In some embodiments, the indication value “0” may indicate that a request/ask to maintain/keep the current sensing configuration without reconfiguration procedure.

Desired sensing configuration: In some embodiments, a sensing status may include the desired/requested sensing configuration which is received/configured from the source cell and used the sensing measurement. In some embodiments, the desired sensing configuration may include the current sensing configuration and/or delta configuration and/or a part of and/or a subset of the current configured sensing configuration. In some embodiments, the desired sensing configuration may comprise one or more set(s) of DL sensing resources/DL-RSs and/or one or time values (e.g., desired time duration/window, desired periodicity) for sensing measurement. In some embodiments, the WTRU may be configured with more than one sets of DL-RS configurations. The WTRU may determine to send one of the configured DL-RS configurations to the target or source cell as the desired configuration. The WTRU may determine to send a request for the configuration to the target cell after the WTRU receives the handover command. The WTRU may include the request in the response for the handover command.

Sensing configuration for handover: In some embodiments, a WTRU may be configured with DL-RS configurations that are associated with more than one cells. The WTRU may be configured with DL-RS configurations that are associated with an area consisting of more than one cells. Based on the source and cell identification information, the WTRU may determine which DL-RS configuration, out of the configured DL-RS configurations, to use. The WTRU may report the determined DL-RS configuration to use to the network. In some embodiments, the WTRU may be configured with a DL-RS configuration (e.g., cell ID, TRP ID, DL-RS ID, DL-RS resource ID) that is associated with cell #1 and cell #2. The WTRU may be in the source cell cell #1. The WTRU may determine that the WTRU is moving into cell #2. In this case, the WTRU may determine to use the DL-RS configuration as the cells associated with the configuration match both source and target cell ID. In some embodiments, if the target cell is cell #3, the WTRU may determine that the WTRU is not configured with the applicable DL-RS configuration and the WTRU may send a request, which may include information about target or source cell, to the network for a new configuration.

Selected set(s) of DL sensing resources/DL-RSs: In some embodiments, a sensing status may include the selected set(s) of DL resource/monitored DL-RS(s) with the sensing configuration. In some embodiments, the selected one or more set(s) of DL resource and/or a range of selected RBs and/or selected BWP(s) and/or selected beam(s). In some embodiments, the monitored one or more DL-RSs (e.g., PSS/SSS, SSB index, specific sensing RSs). In some embodiments, the sensing status may include time duration/values (e.g., slots/msec/sec) with using the selected the set of DL sensing resources/monitored DL-RS(s). In some embodiments, the sensing status may include the hopping pattern with the selected sets of DL sensing resources and/or monitored DL-RS(s).

In some embodiments, the sensing status may include sensing measurement with set(s) of DL sensing resources/DL-RS(s) associated network. In some embodiments, sensing measurement with set(s) of DL sensing resources/DL-RS(s) involved TRP ID(s) and/or cell ID(s).

Remaining time duration: In some embodiments, a sensing status may include time duration/window with the sensing configuration. In some embodiments, the sensing status may include remaining time values (e.g., slots/msec/sec). In some embodiments, remaining time duration/values may indicate remaining time values until the next periodicity. In some embodiments, remaining time duration/values may indicate a specific remaining time (e.g., time reference for sensing measurement). In some embodiments, the WTRU may receive a request from the target cell to report the remaining time. As a response for the report, the WTRU may receive a new time window or duration from the target cell for sensing. The new time window or duration may be associated with a DL-RS configuration which is indicated in the response. The WTRU may determine to perform sensing measurements based on the time window and associated DL-RS configuration.

Sensing measurement report: In some embodiments, a WTRU may send a sensing measurement report when the current sensing measurement is terminated. In some embodiments, a WTRU may send the sensing measurement report with an indication (e.g., sensing measurement is not terminated). In some embodiments, the WTRU may include the selected set(s) of DL resource/DL-RSs with the sensing measurement results. In some embodiments, the WTRU may include the hopping pattern of DL resource/DL-RSs with the sensing measurement results. In some embodiments, the WTRU may include one or more activated conditions with the sensing measurement results. In one example, the WTRU may be configured to process (e.g., average) measurements during a time window. If the time window is interrupted due to HO, the WTRU may determine to complete measurements until the end of the time window or stop measurements when HO takes place. When the WTRU reports sensing measurements to the network, the WTRU may indicate whether the configured processing (e.g., averaging) is completed or not. If the configured processing cannot be completed due to an event (e.g., handover), the WTRU may indicate to the network that the processing on the reported measurements is incomplete and the WTRU may determine to include a cause (e.g., handover) for incomplete processing.

Target information forwarding from the source to the target cell: In some embodiments, a WTRU may receive information related to the target from the source cell. Information related to the target may be one or more of the following: location of the target, mobility status of the target (e.g., whether the target is mobile or not), RCS characteristics of the target (e.g., RCS values). The WTRU may acquire information related to the target after the trigger condition. In some embodiments, the WTRU may inform the source cell about the handover event and the WTRU may receive information about the target from the source cell. In some embodiments, the WTRU may send a request to the source cell for information about the target. In some embodiments, the WTRU may receive a request from the target cell to acquire and/or report information related to the target. The WTRU may determine to send a request to the source cell for information about the target based on the request from the target cell. The WTRU may report information related to the target to the target cell via a response for the handover command, or before or after handover procedure is complete.

Detection of multipath and/or an obstacle: In some embodiments, a WTRU may receive a triggering condition for reporting sensing measurement results. In some embodiments, the triggered condition (e.g., threshold of delayed time of the paths, delay profile, number of detected multipaths/detection of Non-Line-of-Sight (NLOS) path) may be included reporting of sensing measurement results upon detection of multi-path/NLOS path and/or an obstacle. In some embodiments, the WTRU may trigger to perform sensing measurement reporting once at least one multipath/NLOS path and/or an obstacle is detected during performing sensing measurement and/or performing neighboring cell measurement.

In some embodiments, a WTRU may include the detection information of multipath/NLOS/delay profile and/or an obstacle and associated set of DL sensing resources and/or cell/TRP information. In some embodiments, the reported sensing measurement results may inform/indicate (e.g., the set and/or associated DL-RSs/SSB) the set of DL sensing resources and/or cell/TRP and associated information e.g., detected multipath/NLOS path/delay profile/LOS path and/or the obstacle.

Combinations of the above factors/conditions may be also possible. One or another indications/information included in the one reporting message or procedure.

In some embodiments, a WTRU may report the current configuration to a cell (e.g., source cell) for receiving the reconfiguration message by serving network. The current sensing configuration may include the selected sets of DL-resources/DL-RSs. The current sensing configurations may include cell or TRP identification information (e.g., cell ID, TRP ID). In some embodiments, the WTRU may include the current sensing configuration within the measurement report for handover to a cell (e.g., source cell or target cell). In some embodiments, the current sensing configuration may be transmitted via RRC message. In some embodiments, the source cell may deliver the received sensing configuration from the WTRU (e.g., inter-node message and/or container) to the target cell via X2 interface or via NAS signaling with CN.

In certain representative embodiments, a WTRU may receive a configuration (e.g., mobility and/or sensing measurement and reporting) for neighboring cell measurements and sensing measurements from a network. The configuration may include a sensing configuration, e.g., sensing SSB associated one or more sensing DL-RSs, and one or more thresholds.

In some embodiments, a WTRU may determine a candidate cell(s)/TRP(s) among the configured cell(s)/TRP(s) if measured RSRP of SSB is above the configured threshold. In some embodiments, a WTRU may consider measuring a candidate sensing DL-RSs associated with the candidate cell(s)/TRP(s).

In some embodiments, among the candidate cell(s)/TRP(s), a WTRU may determine to measure sensing DL-RSs associated candidate cell(s)/TRP(s) based on measured RSRP of sensing SSBs. When the measured RSRP of sensing SSB is high, the WTRU may determine to perform sensing measurement based on the high priority. The WTRU may determine to measure sensing DL-RSs according to the priority order (e.g., from the highest to lowest).

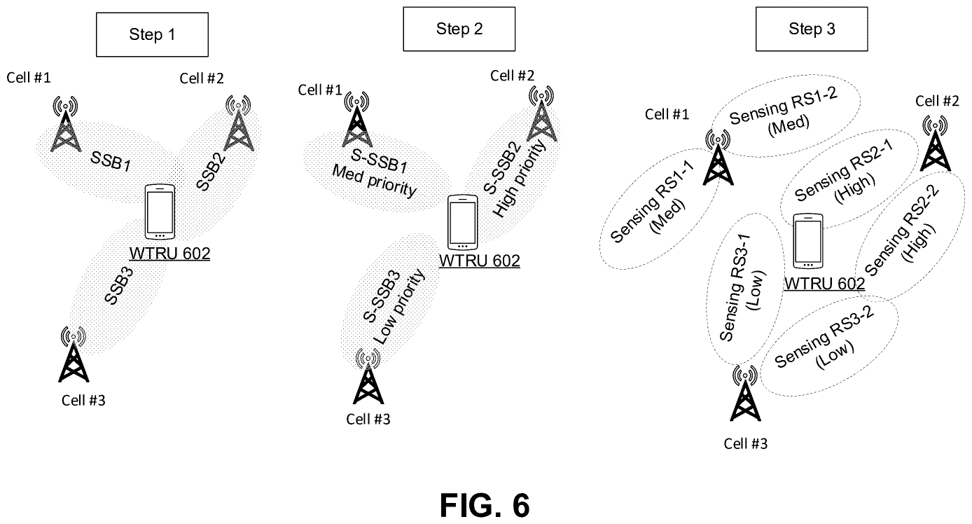

FIG. 6 illustrates a process for determination of a sensing DL-RS for sensing measurement based on prioritization according to one or more embodiments. At step 1, a WTRU 602 may measure SSB (or S-SSB) from neighboring candidate cells/TRPs. At step 2, the WTRU 602 may determine a priority of sensing measurement among the candidate cells/TRPs. In some embodiments, the WTRU 602 may prioritize one or more sensing measurement (e.g., DL sensing RSs associated cell/TRP) based on the measured RSRP of S-SSB from the candidate cell(s)/TRP(s). At step 3, the WTRU may determine to measure sensing DL-RSs associated with an order of priority (i.e., from the highest priority to lowest priority). The WTRU may receive a handover command (e.g., target cell) among the candidate cell during handover procedure. In some embodiment, the determined highest priority (or higher priority) associated cell may be the target cell.

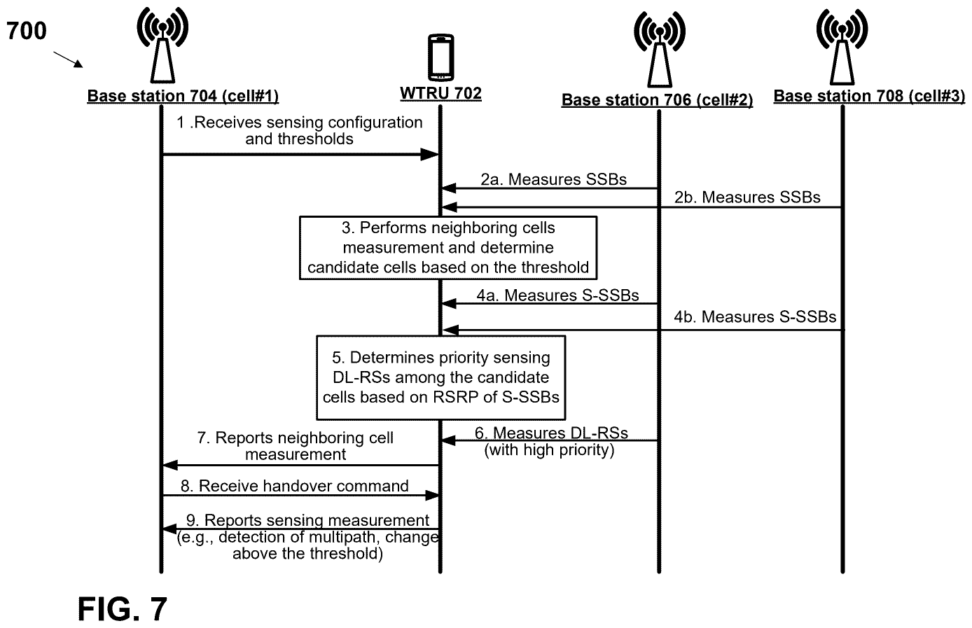

FIG. 7 illustrates a signaling process 700 for sensing measurements continuity according to one or more embodiments. At step 1, A WTRU 702 may receive sensing configuration and thresholds from a base station 704. At steps 2a and 2b, the WTRU 702 may measure SSBs for a base station 706 and a base station 708. At step 3, the WTRU 702 may perform neighboring cells measurement and determine candidate cells based on the threshold. At steps 4a and 4b, the WTRU may measure sensing SSBs for the base stations 706 and 708. At step 5, the WTRU may determine the priority on measurements of DL-RSs based on the RSRP of S-SSB from the cells/TRPs. At step 6, the WTRU 702 may measure DL-RSs based on the determined priority. The DL-RSs associated base station 706 may be a high priority. At step 7, the WTRU 702 may report neighboring cell measurements to the base station 704. At step 8, the WTRU 702 may receive a handover command from the base station 704. At step 9, the WTRU may report sensing measurement results.

In certain representative embodiments, when a WTRU performs sensing and mobility measurement, the WTRU may receive sensing configuration from a target cell during handover procedure.

In certain representative embodiments, a WTRU may perform the following steps/actions: a WTRU (e.g., sensing WTRU) may receive one or more measurement configurations from a network. A first measurement configuration may include neighboring cell(s) and first threshold associated SSB/DL-RSs (e.g., DL-RSRP) and reporting condition. A second measurement configuration may include sensing DL-RSs and second thresholds with sensing DL-RSs (e.g., DL-RSRP, delayed time, number of multipath). The WTRU may perform neighboring cell measurement according to the first measurement configuration. The WTRU may perform sensing measurement according to the second measurement configuration. The WTRU may report the neighboring measurement results to the first cell, if the reporting condition is satisfied. Upon transmitting the measurement results to the first cell, the WTRU may receive an indication (e.g., keep measuring) and/or an RRC message including new (or updated) second measurement configuration from the cell. Upon receiving the indication or new configuration, the WTRU may continue performing sensing measurement according to the indication or configuration with the second cell (e.g., target cell).

In certain representative embodiments, a WTRU may receive sensing configuration during handover procedure. A WTRU may continue performing sensing measurements based on the network (NW) controlled sensing configuration regardless of handover procedure.

In certain representative embodiments, a WTRU may receive more than one measurement configurations from a network. One of the measurement configurations may be related to sensing measurement (e.g., sensing DL-RSs and/or thresholds). The WTRU may receive the configurations from a source or a target cell.

In certain representative embodiments, a WTRU may perform neighboring cell measurements. Upon reporting the neighboring cell measurement to the source cell, the WTRU may receive an indication and/or updated or new configuration for sensing measurement associated to the target cell/candidate cell/configured cell during handover procedure. In certain representative embodiments, the WTRU may receive the indication and/or updated/new sensing configuration via RRC message (e.g., reconfiguration with sync) and/or MAC CE (e.g., LTM cell switch command) and/or DCI (e.g., indication of cell/TRP ID).

In some embodiments, the indication may indicate to keep/maintain/release the current sensing measurement configuration with the cell (e.g., target cell and/or candidate cell). In some embodiments, the WTRU may receive an update of the sensing configuration (e.g., delta value) and/or new sensing configuration with the cell (e.g., target cell and/or candidate cell). In some embodiments, the WTRU may receive an indication to receive and/or update a new sensing configuration with the target cell via SIB.

In some embodiments, the WTRU may be configured with measurement configurations (e.g., DL-RS sequence, DL_RS resource ID) associated with an area. The WTRU may receive more than one measurement configuration where each configuration is associated with an area. An example of an area may be a group of cells where an area ID in the configuration may be associated with more than one cell IDs. During mobility, the WTRU may determine which area the target cell belongs to. The WTRU may determine the area the WTRU is moving into and determine corresponding measurement configuration.

If the WTRU determines that the target cell is not found in configured areas, the WTRU may send a request to the network for measurement configurations. The WTRU may include a cause for the request, e.g., the WTRU does not have measurement configurations for the target cell.

In some embodiments, if the WTRU does not have a measurement configuration for the target cell, the WTRU may indicate termination of sensing to the network. The WTRU may include measurements for sensing in the report.

In some embodiments, the WTRU may receive a request from the network to report additional measurements for the measurements used for mobility. In some embodiments, the WTRU may be configured to report RSRP for SSB as mobility measurements. The WTRU may report a request from the network to report, in addition to RSRP measurements for SSB, time delay profile (e.g., DP or PDP) for the received SSB. The WTRU may receive an activation or deactivation command for the additional measurement from the network. Once the WTRU receives the activation command, the WTRU may report additional measurement (e.g., DP for SSB) with the default measurement (e.g., RSRP for SSB).

In some embodiments, the WTRU may be configured with validity condition(s) for measurement configuration(s). In some embodiments, the WTRU may be configured with area validity for a measurement configuration. The WTRU may determine that the measurement configuration is valid if the WTRU is located inside the area associated with the measurement configuration. In some embodiments, the WTRU may be configured with time validity condition for the measurement configuration. The time validity condition may be expressed in terms of absolute time or relative time with respect to reference time. The time validity condition may be determined based on a timer. In some embodiments, the WTRU may start a timer when the WTRU receives the configuration. The WTRU may determine that the measurement configuration is invalid when the timer reaches the expiry time.

In some embodiments, the WTRU may receive an indication of reference and target measurements in the measurement configuration. In some embodiments, the WTRU may be configured to make the measurements from the serving cell as the reference measurement and measurement from the neighboring cells as the target measurements. The WTRU may determine power, phase and/or time difference measurements from the difference between the reference and target measurements. In some embodiments, the WTRU may determine that the reference and target measurements may be measurements from the target cell and source cell, respectively.

In some embodiments, the WTRU may be configured with priority of measurements (e.g., performing sensing measurement). In some embodiments, the WTRU may receive priority level for a cell or DL-RS. The WTRU may determine to make measurements in the order of priority level. In some embodiments, the priority level for cell #1 and cell #2 may be high and low, respectively. The WTRU may determine to make measurements from cell #1 at first. The WTRU may determine to make measurement from the cell #2 at second.

If the measurement configuration is invalid, the WTRU may determine to send a request for new measurement configurations from the network. The WTRU may include a cause for the request. The WTRU may receive measurement configurations via broadcast, groupcast or unicast via a semi-static message (e.g., RRC, LPP, NAS).

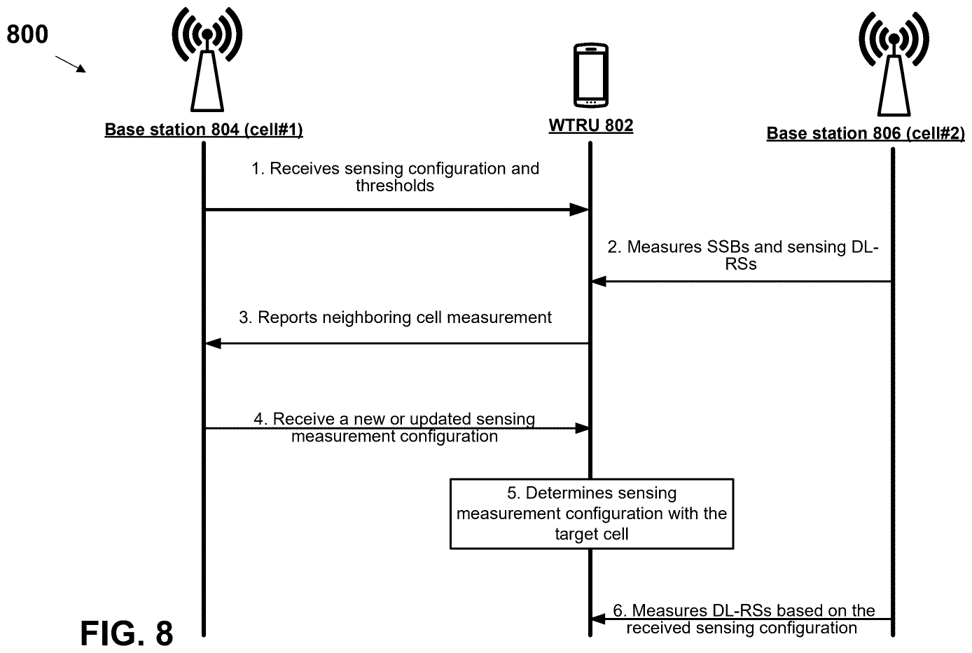

FIG. 8 illustrates a signaling process 800 of NW controlled sensing measurements continuity according to one or more embodiments. A WTRU 802 may receive a new sensing measurement configuration during handover procedure. At step 1, the WTRU 802 may receive sensing configuration and thresholds from a base station 804. At step 2, the WTRU 802 may measure SSBs and sensing DL-RSs for a base station 806. At step 3, the WTRU 802 may report neighboring cell measurement to the base station 804. At step 4, the WTRU 802 may receive 4 a new or updated sensing measurement configuration from the base station 804. At step 5, the WTRU 802 may determine sensing measurement configuration using the target cell based on the received sensing configuration from base station 804. At step 6, the WTRU 802 may measure DL-RSs based on the received sensing configuration.

In certain representative embodiments, when a WTRU performs sensing measurement and handover is triggered, the WTRU may continue sensing measurement with the selected DL sensing resources via the new cell.

In certain representative embodiments, a WTRU may perform the following actions/steps: a WTRU (e.g., sensing WTRU) may receive a sensing configuration from a network. The sensing configuration may include one or more sets of DL sensing resources (e.g., sensing DL-RSs, resource blocks, beam indices, DL-RSs) and associated condition(s). The WTRU may be configured for performing sensing measurements according to the sensing configuration with the first cell (e.g., source cell). The WTRU may select one or more set(s) of DL sensing resources (i.e., dynamic selection) among the configured set(s) of DL sensing resources with the sensing configuration, if satisfied the associated condition(s) (e.g., DL-RSRP, QoS requirement, location). The WTRU may perform sensing measurement using the selected set(s) of DL sensing resources according to the sensing configuration with the first cell. The WTRU may perform neighboring cell measurement for mobility and reports the measurement results to the first cell (e.g., if reporting condition for mobility is satisfied).

Upon receiving a handover command from the first cell, the WTRU may report sensing status to the second cell (e.g., target cell) with an indication (e.g., termination or continuation) and at least one of: selected sets of DL sensing resources and desired sensing configuration with an indication (e.g., continuation), sensing measurement results with selected sets of DL sensing resources and sensing configuration with an indication (e.g., termination), current location information and associated TRP ID(s).

Upon receiving the configuration from the second cell via RRC message or MAC CE, the WTRU may continue performing sensing measurement and reporting sensing measurement results to the second cell (e.g., target cell).

In certain representative embodiments, a WTRU may select DL resource for sensing measurement and report to the target cell when a handover procedure is triggered. In certain representative embodiments, a WTRU may keep performing the sensing measurement based on the selected DL resource via the new target cell.

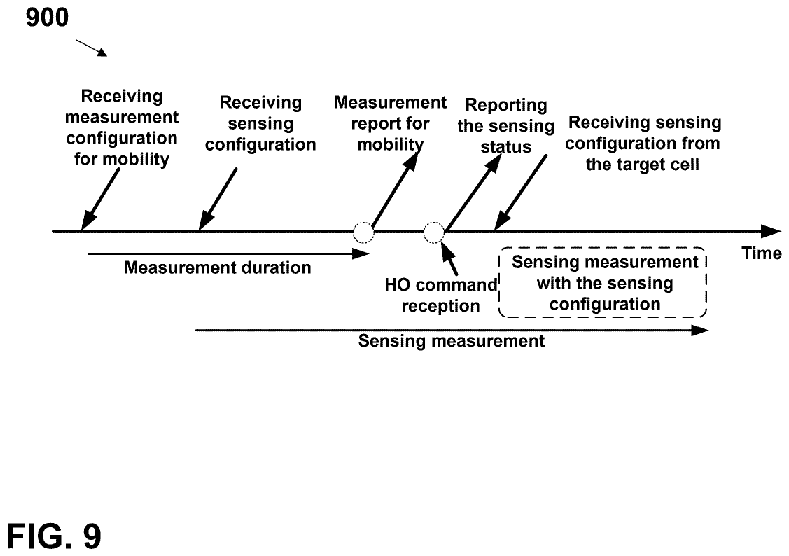

FIG. 9 illustrates a signaling process 900 for sensing measurement continuity according to one or more embodiments. In some embodiments, a WTRU may be configured with sensing configuration and measurement for handover procedure from the cell (e.g., source cell). In some embodiments, a WTRU may report the neighboring cell measurement result to the cell (e.g., source cell) according to measurement events (e.g., periodic-based and/or event-based). The neighboring cell measurement results may include one or more cells (e.g., serving cell and/or a list of neighboring cells) with associated frequencies/cell(s) and measured values (e.g., DL-RSRP/DL-RSRQ).

In some embodiments, a WTRU may report a sensing status to the target cell to support a sensing measurement continuity for sensing measurement with the new target cell (e.g., upon receiving a handover command). Upon transmitting the sensing status to the target cell, a WTRU may receive a new/delta/same sensing configuration and/or a confirmation to maintain the same sensing configuration for supporting sensing measurement continuity.

In some embodiments, the new configuration (e.g., reconfiguration with sensing configuration) may include the same sensing configuration which selected set of DL sensing resources and/or monitored DL-RS(s)/beam(s) with the previous cell (e.g., source cell) to support sensing continuity. In some embodiments, the network may determine the same L1/L2 parameters for sensing configuration with the selected set(s) of DL-resource(s) and/or monitored DL-RS(s) based on the reception of the sensing status from the WTRU.

In some embodiments, the new configuration may include a delta/updated/changed sensing reconfiguration (e.g., compared to current sensing configuration). In some embodiments, the delta sensing reconfiguration may include at least updated one or more set(s) of DL sensing resources and/or hopping pattern for selection and/or updated time values (e.g., time duration/periodicity of sensing configuration).

In some embodiments, the new configuration may include updated reporting operation (e.g., reporting event/reporting time duration/periodicity). In some embodiments, the confirmation response may include that the WTRU may maintain current configured/stored sensing configuration and keep performing the sensing measurement with the new cell (e.g., target cell) after handover procedure.

In some embodiments, the WTRU may report measurements for mobility. The WTRU may report measurements for mobility based on a condition. In some embodiments, the WTRU may receive a request from the network to report measurements (e.g., neighboring cell measurement results) for mobility. The WTRU may determine to send measurement report, if the measurement (e.g., DL-RSRP) for DL signal is below the configured threshold. The WTRU may be configured or receive a request to report sensing measurements from the network. In some embodiments, the network may indicate/request to report the sensing measurement to the target cell or source cell via DCI/MAC CE/RRC message during handover procedure. Upon receiving the indication/request, a WTRU may determine the cell for sensing measurement reporting. In some embodiments, the WTRU may determine to report both sensing measurements and/or sensing status, and measurements for mobility to the network (e.g., target cell) if a trigger condition is satisfied (e.g., DL-RSRP of DL signal is below the configured threshold).

In some embodiments, the WTRU may determine to report both sensing measurements and/or sensing status, and measurements for mobility to the network (e.g., source cell) if a trigger condition is satisfied (e.g., DL-RSRP of DL signal is above the configured threshold). In some embodiments, the WTRU may transmit the sensing status via MAC CE and/or RRC message.

In some embodiments, the WTRU may use a semi-static message (e.g., MAC CE and/or RRC message) to report sensing measurements to the network. In some embodiments, The WTRU may use a dedicated protocol to report sensing measurements. In some embodiments, the WTRU may use the same protocol to report sensing measurements and mobility measurements for mobility.

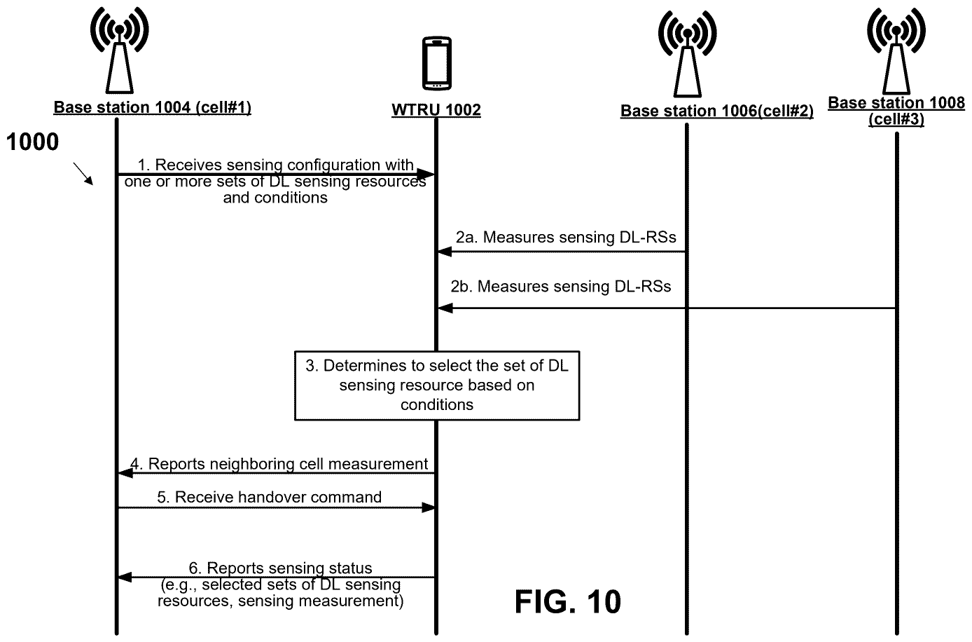

FIG. 10 illustrates signaling process 1000 of NW controlled sensing measurements continuity according to one or more embodiments. A WTRU 1002 may select a set of DL sensing resource and report the sensing status to a target cell. At step 1, the WTRU 1002 may receive sensing configuration with one or more sets of DL sensing resources and conditions from a base station 1004. At steps 2a and 2b, the WTRU 1002 may measure sensing DL-RSs for base stations 1006 and 1008. At step 3, the WTRU 1002 may determine to select the set of DL sensing resource based on at least one condition. At step 4, the WTRU 1002 may report neighboring cell measurement to the base station 1004. At step 5, the WTRU 1002 may receive handover command from the base station 1004. At step 6, the WTRU 1002 may report sensing status (e.g., selected sets of DL sensing resources, sensing measurements to the base station 1004.

In certain representative embodiments, when a WTRU performs sensing measurement and handover is triggered, the WTRU may continue sensing measurement with the selected DL resource via a source cell.

In certain representative embodiments, a WTRU may perform one or more of the following actions/steps: a WTRU (e.g., sensing WTRU) may receive a sensing configuration from a network. The sensing configuration may include one or more sets of DL sensing resources (e.g., resource blocks, beams, sensing DL-RSs, time duration), a first threshold of time duration, and/or a second threshold of DL-RSRP/DL-RSRQ. The WTRU may be configured for performing sensing measurements according to the sensing configuration with a first cell (e.g., source cell). The WTRU may select one or more set(s) of DL sensing resources (i.e., dynamic selection) among the configured set(s) of DL sensing resources with the sensing configuration, if satisfied the associated condition(s) (e.g., DL-RSRP, QoS requirement, location). The WTRU performs sensing measurement using the selected set(s) of DL sensing resources according to the sensing configuration with the first cell. The WTRU may perform neighboring cell measurement for mobility and reports the measurement results to the first cell (e.g., if reporting condition for mobility is satisfied).

Upon receiving a handover command from the first cell, the WTRU may send a request (e.g., to the second cell (target cell)) to perform sensing measurement with the first cell (e.g., with maintaining the current configuration) including remaining time duration, if the following conditions are satisfied: remaining time duration is below the first threshold; and measured DL-RSRP of selected set(s) of DL-resources with the first cell is above the second threshold.

Upon receiving the confirmation from the second cell via RRC message or MAC CE, the WTRU may continue performing sensing measurements with the first cell.

In certain representative embodiments, a WTRU may receive a sensing configuration including sets of DL sensing resources/DL-RSs and associated conditions for performing sensing measurement with the source cell. In some embodiments, a WTRU may receive conditions with one or more thresholds related to the performing sensing measurement with the source cell. In some embodiments, the condition may include a threshold of measured value (e.g., DL-RSRP/DL-RSRQ) with the source cell. In some embodiments, the condition may include a threshold of remaining time duration (e.g., slots/msec/sec) with the current/configured sensing configuration. In some embodiments, the remaining time indicating a specific remaining time within sensing window/duration of the sensing period.

In certain representative embodiments, for sensing measurement continuity, a WTRU may report information (e.g., sensing status) that the current serving network may enable to support/provide a sensing measurement continuity for performing sensing measurement to the WTRU. In some embodiments, the WTRU may trigger to report the sensing status, e.g., upon receiving a handover command message and/or measured DL-RSRP value via target source cell is above than the configured threshold and/or sensing measurement with the current sensing configuration is terminated.

In some embodiments, a WTRU may report a sensing status to the target cell to support a sensing measurement continuity with performing sensing measurement via the current/serving/access source cell upon satisfying the conditions for the sensing measurement with the source cell. In some embodiments, the WTRU may report to the sensing status including a request to perform sensing measurement with the source cell, if the measured DL measurement value of selected sets of DL resource/DL-RSs with the source cell is above the threshold and/or if the measured DL measurement value of selected sets of DL resource/DL-RSs with the source cell is above the threshold (e.g., for obstacle detection) and/or if the measured DL measurement value of DL signal for DL communication with the source cell is above the threshold (e.g., for data communication with the source cell) and/or if the remaining sensing time is below than the configured threshold.

In certain representative embodiments, a WTRU may receive a sensing configuration including sets of DL sensing resources and associated reporting condition. In some embodiments, a condition may indicate to activate and/or select set(s) of DL sensing resources/DL-RSs among the configured set(s) of DL sensing resources/DL-RSs. In some embodiments, the reporting condition may be associated response reporting time (e.g., maximum response time, Quality of Service (QoS) requirement).

In some embodiments, upon receiving a handover command, a WTRU may report indication of service interruption (e.g., sensing measurement) to the cell (e.g., source cell or target cell), if at least the estimated required time for handover procedure is longer than the received response reporting time. In some embodiments, the service interruption time may comprise a time for re-access procedure to the target cell including RACH procedure and/or DL-synchronization signal/detecting MIB/SIB). In some embodiments, a WTRU may report the indication of service interruption via dedicated RACH preamble/UCI/MAC CE/RRC message/NAS message to the network.

In some embodiments, the indication of service interruption may include a termination of sensing measurement with current sensing configuration and/or a request of delaying handover procedure with including the required delaying time (e.g., msecs/sec) and/or a request for new sensing configuration considering the service interruption and/or a request to perform sensing measurement with the current sensing measurement with service interruption and/or a request to perform suspension of sensing measurement with the current sensing measurement during the service interruption and/or a request to configure a time gap of sensing measurement and/or a resumption of sensing measurement after time duration (e.g., after service interruption).

In some embodiments, a WTRU may report an indication for the service interruption with simplified pre-configured/pre-associated information. In some embodiments, the indication “00” may indicate a request of termination and/or “01” may indicate a request of new sensing configuration and/or “10” may indicate a suspension of sensing measurement and/or “11” a resumption of sensing measurement.

In some embodiments, the WTRU may receive a request to process measurements. An example of processing may be averaging. The WTRU may be configured to process measurements (e.g., determine the mean value of RSRP measurements for a DL-RS) outside of the handover process. The WTRU may be configured to process measurements during and outside of the handover process. In some embodiments, the WTRU may report that the measurements are not processed during the handover process. In some embodiments, the WTRU may be configured to stop or interrupt processing measurements during the handover process. The WTRU may determine to stop processing measurements when the WTRU receives the handover command from the network. The WTRU may restart processing after the handover process is complete.

In some embodiments, the WTRU may be configured with different types of measurements during mobility. In some embodiments, the WTRU may be configured to report L1 measurements (e.g., L1 RSRP in physical layer) for sensing purpose outside of the mobility procedure (e.g., when the WTRU is located in the serving cell). During mobility procedure, the WTRU may be configured to report L2 or L3 measurements (e.g., L2 RSRP in MAC layer, L3 RSRP in RRC layer) for sensing purpose.

In some embodiments, upon transmitting indication of service interruption to a network, a WTRU may receive a new sensing configuration. The new sensing configuration may include a delta/updated/changed sensing reconfiguration. In some embodiments, the delta sensing reconfiguration may include at least updated one or more set(s) of DL sensing resources/DL-RSs and/or hopping pattern for selection. In some embodiments, the delta sensing reconfiguration may include at least updated time values of the sensing configuration (e.g., time duration/periodicity of sensing configuration and/or a gap of sensing measurement) considering the service interruption time due to the handover procedure.

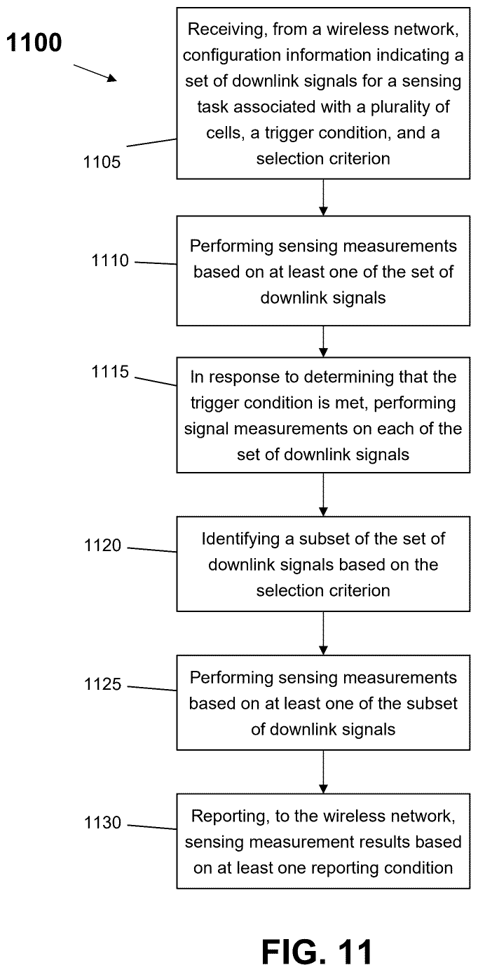

FIG. 11 illustrates a method 1100 for sensing measurement continuity according to one or more embodiments. The method 1100 may be performed by a WTRU such as any of the WTRUs 102 of FIGS. 1A-1D, the WTRU 402 of FIG. 4, the WTRU 502 of FIG. 5, the WTRU 602 of FIG. 6, the WTRU 702 of FIG. 7, the WTRU 802 of FIG. 8, or the WTRU 1002 of FIG. 10. The method 1100 may include receiving 1105, from a network, configuration information indicating a set of downlink signals for a sensing task associated with a plurality of cells, a trigger condition, and a selection criterion. In some embodiments, the receiving 1105 may correspond to step 1 of FIG. 7-8 or 10. The method 1100 may further include performing 1110, sensing measurements based on at least one of the set of downlink signals. The method 1100 may further include, in response to determining that the trigger condition is met, performing 1115, signal measurements on each of the set of downlink signals. In some embodiments, the performing 1115 corresponds to steps 4a-4b FIG. 7. The method 1100 may further include identifying 1120, a subset of the set of downlink signals based on the selection criterion. In some embodiments, the identifying 1120 corresponds to step 5 of FIG. 7. The method 1100 may further include performing 1125, sensing measurements based on at least one of the subset of downlink signals. In some embodiments, the performing 1125 corresponds to step 7 of FIG. 7. The method 1100 may further reporting 1130, to the wireless network, sensing measurement results based on at least one reporting condition. In some embodiments, the reporting 1130 corresponds to step 9 of FIG. 7.

In some embodiments, the measurement configuration information may comprise at least one of: an indication of at least one sensing target object, an indication of at least one sensing location, a downlink signal associated with the logged sensing task, or a periodicity or a time duration associated with the logged sensing task.

In some embodiments, the selection criterion may comprise having a signal quality above a threshold; and identifying the subset of the set of downlink signals may comprise identifying the subset of the set of downlink signals having a signal quality above the threshold. The method 1100 may further include determining an order of priority for measurement the subset of downlink signals based on the signal quality for sensing measurements and determining the at least one of the subset of downlink signals based on the order of priority.

In some embodiments, the method 1100 may further include reporting, to the wireless network, the signal measurement results, receiving, from the wireless network, information associated with a target cell; and reporting sensing measurement results based on the at least one reporting condition to a source cell or the target cell.

In some embodiments, the method 1100 may further include reporting, to the wireless network, the signal measurements results; and in response to receiving a handover command, reporting, to the wireless network, a sensing status comprising an indication and at least one of: selected sets of downlink sensing resources and a desired sensing configuration information, a request for sensing measurement with a source cell, sensing measurement results with selected sets of downlink sensing resources, or current geographical location information and associated Transmission Reception Point (TRPs) identifiers.

In some embodiments, the indication may comprise a continuation or a termination of the sensing task.

In some embodiments, the configuration information may comprise a first configuration information, and the method 1100 may further include receiving second configuration information different from the first configuration information; and performing sensing measurements based on the second configuration information.

In some embodiments, the at least one reporting condition comprises at least one of: detecting a multipath or Non-Line-Of-Sight signal or an obstacle, detecting a change in the sensing measurements above a threshold, a time period, or receiving an activation command for configuration of a sensing task.

In some embodiments, the receiving, from the wireless network, the configuration information may comprise receiving the configuration information via at least one of: Non-Access Stratum (NAS) layer signaling, Access Stratum (AS) layer signaling, Radio Resource Control (RRC) System Information Block (SIB), RRC dedicated message, and receiving an activation command via at least Downlink Control Information (DCI), or Medium Access Control (MAC) Control Element (CE), or RRC message.

In some embodiments, the reporting condition comprises a time period, and the method 1100 may further include receiving, from the wireless network, a handover command; and in response to determining that a time for a handover procedure is greater than the time period, reporting, to the wireless network, an indication of service interruption.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
receiving, from a wireless network, configuration information indicating a set of downlink signals for a sensing task associated with a plurality of cells, a trigger condition, and a selection criterion;
performing sensing measurements based on at least one of the set of downlink signals;
in response to determining that the trigger condition is met, performing signal measurements on each of the set of downlink signals;
identifying a subset of the set of downlink signals based on the selection criterion;
performing sensing measurements based on at least one of the subset of downlink signals; and
reporting, to the wireless network, sensing measurement results based on at least one reporting condition.

2. The method of claim 1, wherein the trigger condition comprises at least one of receiving an activation signal from the wireless network, determining that a signal quality is below a threshold, a quality of service (QoS) requirement, or a geographical location of the WTRU.

3. The method of claim 1, wherein:
the selection criterion comprises having a signal quality above a threshold; and
identifying the subset of the set of downlink signals comprises:
identifying the subset of the set of downlink signals having a signal quality above the threshold; and
the method further comprises:
determining an order of priority for the subset of downlink signals based on the signal quality for sensing measurements; and
determining the at least one of the subset of downlink signals based on the order of priority.

4. The method of claim 1, further comprising:
reporting, to the wireless network, signal measurement results; and
receiving, from the wireless network, information associated with a target cell.

5. The method of claim 1, further comprising:
reporting, to the wireless network, signal measurements results; and
in response to receiving a handover command, reporting, to the wireless network, a sensing status comprising a sensing indication and at least one of: selected set information of downlink sensing resources and a desired sensing configuration information, a request for sensing measurement with a source cell, sensing measurement results with selected sets of downlink sensing resources, or current geographical location information and associated Transmission Reception Point (TRPs) identifiers.

6. The method of claim 5, wherein the sensing indication comprises a continuation or a termination of the sensing task.

7. The method of claim 5, wherein the configuration information is a first configuration information, and the method further comprises:
receiving second configuration information different from the first configuration information; and
performing sensing measurements based on the second configuration information.

8. The method of claim 1, wherein the at least one reporting condition comprises at least one of detecting a multipath or Non-Line-Of-Sight signal or an obstacle, detecting a change in the sensing measurements above a threshold, a time period, or receiving an activation command for configuration of a sensing task.

9. The method of claim 1, wherein:
the receiving, from the wireless network, the configuration information comprises:
receiving the configuration information via at least one of Non-Access Stratum (NAS) layer signaling, Access Stratum (AS) layer signaling, Radio Resource Control (RRC) System Information Block (SIB), RRC dedicated message, and receiving an activation command via at least Downlink Control Information (DCI), or Medium Access Control (MAC) Control Element (CE), or RRC message.

10. The method of claim 1, wherein the at least one reporting condition comprises a time period, and the method further comprises:
receiving, from the wireless network, a handover command; and
in response to determining that a time for a handover procedure is greater than the time period, reporting, to the wireless network, an indication of service interruption.

11. A wireless transmit/receive unit (WTRU) comprising:
a processer; and
a transceiver, wherein the WTRU is configured to:
receive, from a wireless network, configuration information indicating a set of downlink signals for a sensing task associated with a plurality of cells, a trigger condition, and a selection criterion;
perform sensing measurements based on at least one of the set of downlink signals;
in response to determining that the trigger condition is met, perform signal measurements on each of the set of downlink signals;
identify a subset of the set of downlink signals based on the selection criterion;
perform sensing measurements based on at least one of the subset of downlink signals; and
report, to the wireless network, sensing measurement results based on at least one reporting condition.

12. The WTRU of claim 11, wherein the trigger condition comprises at least one of receiving an activation signal from the wireless network, determining that a signal quality is below a threshold, a quality of service (QoS) requirement, or a geographical location of the WTRU.

13. The WTRU of claim 11, wherein:
the selection criterion comprises having a signal quality above a threshold; and
the WTRU is configured to identify the subset of the set of downlink signals by:
identifying the subset of the set of downlink signals having a signal quality above the threshold; and
the WTRU is further configured to:
determine an order of priority for the subset of downlink signals based on the signal quality for sensing measurements; and
determine the at least one of the subset of downlink signals based on the order of priority.

14. The WTRU of claim 11, wherein the WTRU is further configured to:
report, to the wireless network, signal measurement results; and
receive, from the wireless network, information associated with a target cell.

15. The WTRU of claim 11, wherein the WTRU is further configured to:
report, to the wireless network, signal measurements results; and
in response to receiving a handover command, report, to the wireless network, a sensing status comprising a sensing indication and at least one of: selected set information of downlink sensing resources and a desired sensing configuration information, a request for sensing measurement with a source cell, sensing measurement results with selected sets of downlink sensing resources, or current geographical location information and associated Transmission Reception Point (TRPs) identifiers.

16. The WTRU of claim 15, wherein the sensing indication comprises a continuation or a termination of the sensing task.

17. The WTRU of claim 15, wherein the configuration information is a first configuration information, and the WTRU is further configured to:
receive second configuration information different from the first configuration information; and
perform sensing measurements based on the second configuration information.

18. The WTRU of claim 11, wherein the at least one reporting condition comprises at least one of detecting a multipath or Non-Line-Of-Sight signal or an obstacle, detecting a change in the sensing measurements above a threshold, a time period, or receiving an activation command for configuration of a sensing task.

19. The WTRU of claim 11, wherein the WTRU is configured to receive, from the wireless network, the configuration information by:
receiving the configuration information via at least one of Non-Access Stratum (NAS) layer signaling, Access Stratum (AS) layer signaling, Radio Resource Control (RRC) System Information Block (SIB), RRC dedicated message, and receiving an activation command via at least Downlink Control Information (DCI), or Medium Access Control (MAC) Control Element (CE), or RRC message.

20. The WTRU of claim 11, wherein the at least one reporting condition comprises a time period, and wherein the WTRU is further configured to:
receive, from the wireless network, a handover command; and
in response to determining that a time for a handover procedure is greater than the time period, report, to the wireless network, an indication of service interruption.
